(19) United States
(12) Patent Application Publication
(10) Pub. No.: US 2008/0268997 A1
(43) Pub. Date: Oct. 30, 2008

(54) Lubrication path in a planetary gear unit for a transmission

(76) Inventor: James T. Gooden, Canton, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/789,772

(22) Filed: Apr. 24, 2007

(51) Int. Cl. F16H 57/04

(52) U.S. Cl. 475/160

(57) ABSTRACT

A planetary gear unit includes a sun gear supported for rotation about an axis and including gear teeth, and a pinion supported for rotation, including pinion teeth engaged with the sun gear teeth and formed with a first passage located between consecutive teeth of the pinion and directed radially toward the engagement of the sun gear and the pinion.

### BACKGROUND OF THE INVENTION

1. Field of the Invention

This invention relates generally to a planetary gear unit for an automatic transmission, and more particularly to fluid flow path in the gear unit for lubricating the gear mesh between a planet pinion and sun gear.

2. Description of the Prior Art

A conventional Ravigneaux gearset includes a carrier containing two sets of planet pinions, long pinions and short pinions. Each pinion set includes several pinions mutually spaced angularly about a central axis, each short pinion meshing with a corresponding long pinion. There are two sun gears, a short sun gear meshing with the long pinions, and a long sun gear meshing with the short pinions. A ring gear meshes with the long pinions.

Both planet pinion sets are supported for rotation on the carrier. Each long pinion is in mesh with a short pinion, the ring gear, and the short sun gear. Each short pinion is in mesh with a long pinion and the long sun gear.

Ravigneaux gearsets are used in many automatic transmissions due to their compact size. A Ravigneaux gearset can be used in lieu of two simple planetary gearsets to produce four forward speeds and a reverse gear. They are smaller, and require fewer components than two simple planetary gearsets because they have one ring gear, and one carrier. Their manufacturing and assembly costs compare favorably to those of simple planetary gearsets.

In transmission development, it is important that the planetary gearset completes durability testing without pitting gear teeth. Gear tooth pitting is partially caused by the absence or inadequacy of fluid lubricant on the gear tooth faces of the meshing pinions and gears. It is difficult to prevent pitting on sun gear teeth by merely increasing lubricant flow into the carrier, because rotation of the carrier causes lubricant to spin spins away from the sun gear at the center of the carrier assembly.

One attempt to avoid pitting of sun gear teeth is to provide lubricant passages in the sun gear, but this only lubricates the surfaces of the teeth directly adjacent to the passage openings. Oil spins away from the sun gear, leaving the other gear teeth unlubricated.

There is a need in the automatic transmission industry to provide a flow path for liquid lubricant to exit the pinion gear and lubricate the gear mesh where the pinion engages the sun gear.

### SUMMARY OF THE INVENTION

A planetary gear unit includes a sun gear supported for rotation about an axis and including gear teeth, and a pinion supported for rotation, including pinion teeth engaged with the sun gear teeth and formed with a first passage located between consecutive teeth of the pinion and directed radially toward the engagement of the sun gear and the pinion.

A portion of the lubricant that is routed inside the pinion gear by various methods exits the pinion gear through radial holes placed axially in the middle of the pinion gear. As the gear rotates, the oil is slung out this radial lube hole, spraying the ring gear and the sun gear as it the planet pinions rotate on the carrier. The lubricant is sprayed radially inward against all the sun gear teeth, thereby reducing the risk of gear tooth pitting.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a cross section of a planetary gear unit for an automatic transmission;

FIG. 2 is an end view at plane 2-2 showing the gear assembly of FIG. 1 arranged about a central axis; and

FIG. 3 is a cross section showing a typical radial passage formed in each of the planet pinions.

### DESCRIPTION OF THE PREFERRED EMBODIMENT

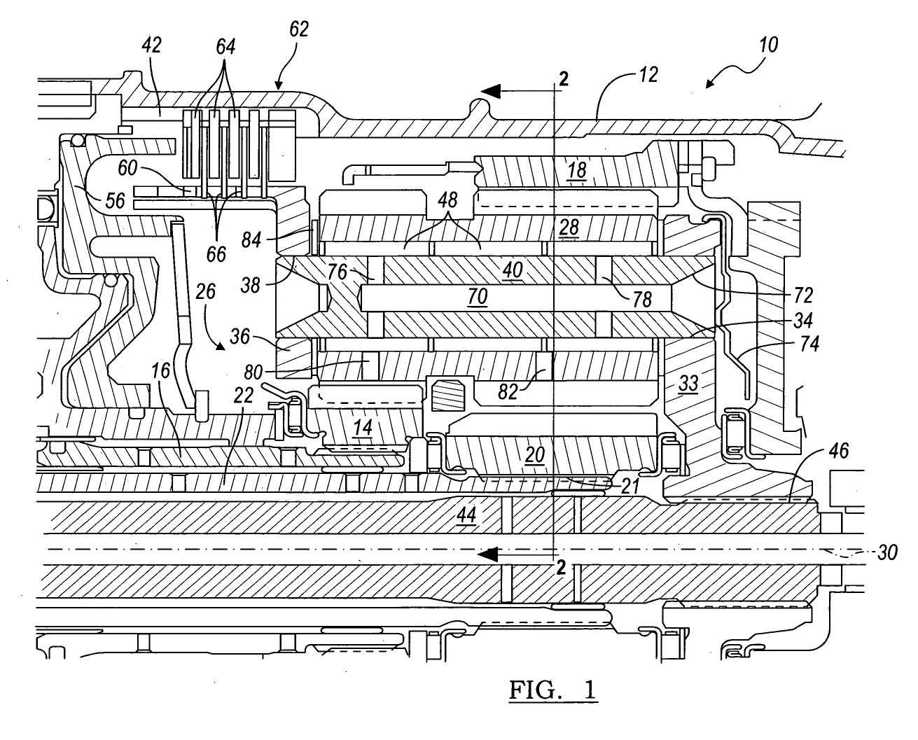

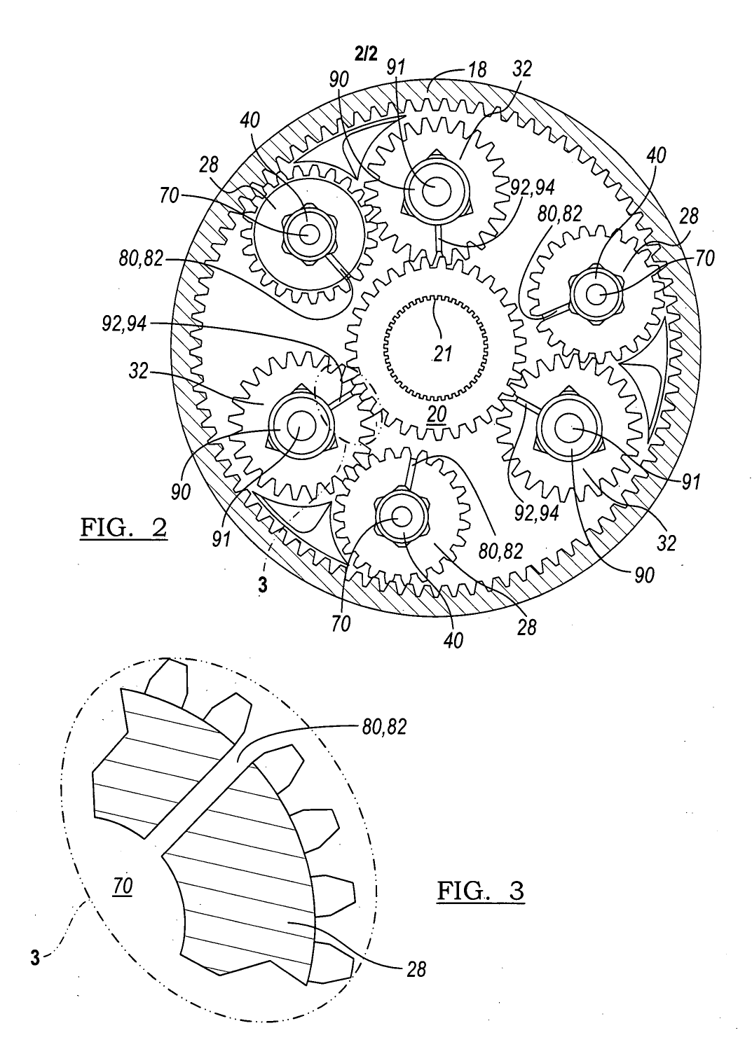

Referring to FIGS. 1 and 2, a planetary gear unit assembly 10 of the Ravigneaux type located in a transmission case 12 includes a first sun gear 14, connected by a spline to a rotating shaft 16; a second sun gear 20, connected by a spline 21 to a rotating shaft 22; a planet pinion carrier assembly 26, which is supported for rotation and includes a set of long planet pinions 28, each spaced angularly about an longitudinal axis 30, supported on the carrier 26 and meshing with sun gear 14; a set of short planet pinions 32, each spaced angularly about axis 30, supported on carrier 26 and meshing with sun gear 20 and a long pinion 28. The gear assembly 10 further includes a ring gear 18 surrounding the long pinions 28, short pinions 32, and sun gears 14, 20 and engaged with the long pinions 28.

The carrier assembly 26 includes a first disc 33, formed with axial holes 34, spaced angularly about axis 30; a second disc 36, which is spaced axially from the first disc 33 and is formed with axial holes 38, each aligned with a hole 34; and pinion shafts 40, each supported on the discs 33, 36 and extending axially through the holes 34 and 38. Discs 33 and 36 are formed integrally as a unitary component. Disc 33 is secured to shaft 44 by a spline 46.

Bearings 48, fitted between the outer surface of each pinion shaft 40 and the inner surface of a corresponding long pinion 28, support the long pinions 28 in rotation on the pinion shafts 40.

The transmission case 12 is formed at an inner surface with axial spline teeth 42. A hydraulically actuated friction brake 62 includes clutch plates 64, which are spaced mutually and rotatably secured to the case 12 by engagement with spline teeth 42. Frictions discs 66, each interleaved between successive clutch plates 64, are rotatably secured to the disc 36 by engagement with its spline teeth 60. A hydraulically actuated brake piston 56 produces a drive connection between the case 12 and carrier 26 when it moves rightward, thereby forcing the plates 64 and discs 66 into mutual frictional contact.

The pinion shaft 40 is formed with a center axial bore 70 located at the end of a conical passage 72. A lube deflector 74, secured to disc 33, directs automatic transmission fluid, a lubricant and coolant, into passages 72 and 70. Pinion shaft 40 is formed with a first set of axially-spaced radial holes 76, 78, which communicate with passage 70 and bearings 48.

As FIG. 2 illustrates, carrier assembly 26 further includes pinion shafts 90, similarly angularly spaced mutually about axis 30 and supported on discs 33 and 36. Each pinion shaft 90 supports a pinion 32 and is formed with a center axial bore 91 located at the end of a conical passage 72, similarly as shown in FIG. 1. The lube deflector 74 directs automatic transmission fluid into passage 91 of each pinion shaft 90. Each pinion shaft 90 is formed with a first set of axially-spaced radial holes 76, 78, which communicate with passage 91 and bearings 48, which are fitted between the outer surface of each pinion shaft 90 and the inner surface of a corresponding pinion 32 to support the pinions 32 in rotation on the pinion shafts 90.

Located between consecutive teeth of each long planet pinion 28 is a first set of axially-spaced radial holes 80, 82, which are located axially substantially at the center of the meshes, where sun gear 14 and planet pinions 28 are mutually engaged and where sun gear 20 and the long planet pinions 32 are mutually engaged, respectively. Similarly, located between consecutive teeth of each planet pinion 32 is a set of axially-spaced radial holes 92, 94, which are located axially substantially at the center of the meshes, where sun gear 14 and planet pinions 28 are mutually engaged and where sun gear 20 and the planet pinions 32 are mutually engaged, respectively.

In operation, lubricant in passages 72 enters the axial passages 70, 91 with which it communicates, flows through radial holes 76, 78, thereby lubricating bearings 48 as it flows axially through the bearings. Lubricant exiting the bearings 48 at each end of pinions 28, 32 is thrown radially outward onto and through thrust washers 84, which are located between the face of discs 33, 36 and the adjacent face of planet pinions 28, 32. Lubricant flowing through radial holes 80, 82 and 92, 94 is directed radially inward to the sun gears 14, 20, thereby lubricating the gear meshes between sun gear 14 and planet pinions 28 and between sun gear 20 and planet pinions 32.

FIG. 3 illustrates one of the fluid passages 80, 82 located between consecutive teeth of a planet pinion 28, which mesh with sun gear 20.

Although the invention has been described with reference to a Ravigneaux carrier, which supports two sets of pinions, pinions 28 engaged with sun gear 20, and pinions 40 engaged with sun gear 14, the lubricant passages 80, 82 or 92, 94 may be formed in any simple planetary carrier, which supports one set of pinions engaged with a sun gear.

In accordance with the provisions of the patent statutes, the preferred embodiment has been described. However, it should be noted that the alternate embodiments can be practiced otherwise than as specifically illustrated and described.

What is claimed is:

1. A planetary gear unit, comprising:
a sun gear supported for rotation about an axis and including gear teeth;
a pinion supported for rotation, including pinion teeth engaged with the sun gear teeth and formed with a first passage located between consecutive teeth of the pinion and directed radially toward the engagement of the sun gear and the pinion.

2. The gear unit of claim 1 further comprising:
a pinion shaft on which the pinion is supported, formed with a central passage extending along a length of the pinion shaft and a radial passage communicating with the central passage; and
a bearing supporting the pinion for rotation on the pinion shaft, the radial passage directed from the central passage toward the bearing.

3. The gear unit of claim 1 further comprising:
a pinion shaft on which the pinion is supported, formed with a central passage extending along a length of the pinion shaft, a radial passage communicating with the central passage;
a bearing supporting the pinion for rotation on the pinion shaft, the radial passage directed from the central passage toward the bearing; and
a lube deflector located at an axial end of the central passage and defining a channel in which fluid is directed into the central passage.

4. A planetary gear unit, comprising:
a first sun gear supported for rotation about an axis and including gear teeth;
a second sun gear spaced axially from the first sun gear, supported for rotation about the axis and including gear teeth;
a first pinion supported for rotation, including first pinion teeth engaged with the first sun gear teeth, formed with a first passage located between consecutive first pinion teeth and directed radially toward the engagement of the first sun gear and the first pinion; and
a second pinion supported for rotation and including second pinion teeth engaged with the second sun gear teeth and the first pinion, and formed with a second passage located between consecutive second pinion teeth and directed radially toward the engagement of the second sun gear and the second pinion.

5. The gear unit of claim 4 further comprising:
a first pinion shaft on which the first pinion is supported, formed with a first central passage extending along a length of the first pinion shaft, and a first radial passage communicating with the first central passage;
a second pinion shaft on which the second pinion is supported, formed with a second central passage extending along a length of the second pinion shaft, and a second radial passage communicating with the first central passage; and
a first bearing supporting the first pinion for rotation on the first pinion shaft, the first radial passage being directed from the first central passage toward the first bearing; and
a second bearing supporting the second pinion for rotation on the second pinion shaft, the second radial passage being directed from the second central passage toward the second bearing.

6. The gear unit of claim 4 further comprising:
a first pinion shaft on which the first pinion is supported, formed with a first central passage extending along a length of the first pinion shaft, and a first radial passage communicating with the first central passage;
a second pinion shaft on which the second pinion is supported, formed with a second central passage extending along a length of the second pinion shaft, and a second radial passage communicating with the first central passage; and
a first bearing supporting the first pinion for rotation on the first pinion shaft, the first radial passage being directed from the first central passage toward the first bearing; and
a second bearing supporting the second pinion for rotation on the second pinion shaft, the second radial passage being directed from the second central passage toward the second bearing;
a first lube deflector located at an axial end of the first and second central passages and defining a first channel in which fluid is directed into the first and second central passages.

7. A planetary gear unit, comprising:
a sun gear supported for rotation about an axis and including gear teeth;
a carrier supported for rotation about the axis;
pinion shafts angularly spaced about the axis and supported on the carrier, each pinion shaft being formed with a central passage extending along a length of the pinion shaft, and a radial passage communicating with the central passage;
a set of pinions, each pinion supported for rotation on one of the pinion shafts, including pinion teeth engaged with the sun gear teeth, and formed with a first passage located between consecutive teeth of the pinion and directed radially toward the engagement of the sun gear and the pinion.

8. The gear unit of claim 7, further comprising:
bearings, each bearing supporting one of the pinions for rotation on one of the pinion shafts, each radial passage being directed from one of the central passages toward one of the bearings.

9. The gear unit of claim 8, further comprising:
a lube deflector located at an axial end of each central passage and defining a channel in which fluid is directed into one of the central passages.
